(19) United States
(12) Patent Application Publication
(10) Pub. No.: US 2024/0185577 A1
(43) Pub. Date: Jun. 6, 2024

(54) REINFORCED ATTENTION

(71) Applicant: Bayer Aktiengesellschaft, Leverkusen (DE)

(72) Inventors: Matthias LENGA, Leverkusen (DE); Marvin PURTORAB, Burton-Upon-Trent (GB); Thiago RAMOS DOS SANTOS, London (GB); Jens HOOGE, Leverkusen (DE); Veronica CORONA, London (GB)

(73) Assignee: Bayer Aktiengesellschaft, Leverkusen (DE)

(21) Appl. No.: 18/285,361

(22) PCT Filed: Mar. 24, 2022
(86) PCT No.: PCT/EP2022/057746

§ 371 Date: Oct. 2, 2023

(30) Foreign Application Priority Data
Apr. 1, 2021 (EP) 21166511.2

(51) Int. Cl. G06V 10/774; G06V 10/22; G06V 10/32; G06V 10/82

(52) U.S. Cl. CPC G06V 10/774; G06V 10/22; G06V 10/32; G06V 10/82; G06V 2201/031

(57) ABSTRACT

The present invention relates to the technical field of machine learning. Subject matter of the present invention is a novel approach for training a neural network and the use of this approach for the processing of (medical) images.

### CROSS-REFERENCE TO RELATED APPLICATIONS

This application is a national stage application under 35 U.S.C. § 371 of International Application No. PCT/EP2022/057746, filed internationally on Mar. 24, 2022, which claims the benefit of priority to European Application No. 21166511.2, filed Apr. 1, 2021.

### FIELD

The present invention relates to the technical field of machine learning. Subject matter of the present invention is a novel approach for training a neural network and the use of this approach for the processing of (medical) images.

### BACKGROUND

Medical imaging is the technique and process of imaging the interior of a body for clinical analysis and medical intervention. Medical imaging can also provide visual representations of the function of organs or tissues (physiology). Medical imaging seeks to reveal internal structures hidden by the skin and bones, as well as to diagnose and/or treat diseases.

Advances in both imaging and machine learning have synergistically led to a rapid increase in interest in the potential use of artificial intelligence in various medical imaging tasks, such as risk assessment, detection, diagnosis, prognosis, and therapy response.

Many publications relate to the use of a machine learning model for the classification of (medical) images (see, e.g., EP3567525A1, US20210035287A1).

However, when a machine learning model is trained to classify images, the features of the images on which a classification result is (primarily) based are not apparent from the model. This is a possible source of systematic error. For example, if a machine learning model is trained to classify images of lepidoptera (butterflies, moths) into one of two classes, one class containing butterflies, the other class containing moths, and each training image showing a moth was taken at night, while each image showing a butterfly was taken during the day, it is possible that the machine learning model learns to distinguish between day and night instead of between moths and butterflies. This systematic error may remain undetected as long as no image that shows either a moth by day or a butterfly by night is fed into the machine learning model.

There exist techniques that aim to make visible the features or regions of images the machine learning model is focusing on when performing, e.g., a classification (see, e.g., W. Samek: Evaluating the visualization of what a Deep Neural Network has learned, arXiv:1509.06321v1 [cs.CV], 2015). However, such techniques can only be used to assess what a machine learning model has learned after the training process. Such techniques have no influence on where the machine learning model should focus during training in order to learn “the right thing”.

Accordingly, there is need to improve the training of machine learning models.

### SUMMARY

The problem discussed in the preceding section is solved by the subject matter of the independent claims of the present invention. Preferred embodiments of the present invention are defined in the dependent claims and described in the present specification and/or displayed in the figures.

Provided herein is a computer-implemented method of training a machine learning model to perform a task based on an image. The machine learning model may comprise a transformation agent and a task performing agent, and the method may comprise:
receiving a training set comprising a multitude of images,
feeding each image of the training set to the transformation agent, wherein the transformation agent is configured to apply one or more image transformations to each image based, at least in part, on a set of transformation parameters,
feeding each transformed image to the task performing agent, wherein the task performing agent is configured to perform a task on each transformed image,
determining, for each task performed by the task performing agent, a task performance loss, and
training the transformation agent to optimize the set of transformation parameters, based, at least in part, on minimizing the task performance loss.

Additionally, provided is a computer system comprising a processor and a memory storing an application program configured to perform, when executed by the processor, an operation, the operation comprising:
receiving a training set comprising a multitude of images,
feeding each image of the training set to a transformation agent, wherein the transformation agent is configured to apply one or more image transformations to each image based, at least in part, on a set of transformation parameters,
feeding each transformed image to a task performing agent, wherein the task performing agent is configured to perform a task on each transformed image,
determining, for each task performed by the task performing agent, a task performance loss, and
training the transformation agent to optimize the set of transformation parameters, based, at least in part, on minimizing the task performance loss.

Furthermore, provided is a computer-readable storage medium comprising instructions that, when executed by a computer, cause the computer to:
receive a training set comprising a multitude of images,
feed each image of the training set to a transformation agent, wherein the transformation agent is configured to apply one or more image transformations to each image based, at least in part, on a set of transformation parameters,
feed each transformed image to a task performing agent, wherein the task performing agent is configured to perform a task on each transformed image,
determine, for each task performed by the task performing agent, a task performance loss, and
train the transformation agent to optimize the set of transformation parameters, based, at least in part, on minimizing the task performance loss.

### BRIEF DESCRIPTION OF THE FIGURES

The invention will now be described, by way of example only, with reference to the accompanying drawings.

FIG. 1 shows a masking operation on an image, according to some embodiments.

FIG. 2 shows a cropping operation on an image, according to some embodiments.

FIG. 3 shows variable and fixed transformation parameters for the selection of a region of interest, according to some embodiments.

FIG. 4 shows a reinforcement learning (RL) process, according to some embodiments.

FIG. 5 shows an actor-critic reinforcement learning approach, according to some embodiments.

FIG. 6 shows an actor-critic reinforcement learning approach, according to some embodiments.

FIG. 7 shows the use of an actor-critic reinforcement learning approach for training a machine learning model, according to some embodiments.

FIG. 8 shows a variant of the actor-critic reinforcement learning approach shown in FIG. 7.

FIG. 9 shows a trained machine learning model performing tasks on new images, according to some embodiments.

FIG. 10 shows a machine learning model being trained to classify a subject patient into one of two classes, according to some embodiments.

FIG. 11 shows a trained machine learning model for classifying subject patients based on an image, according to some embodiments.

FIG. 12 shows a machine learning model being trained to determine values of parameters associated with a patient's heart, according to some embodiments.

FIG. 13 shows a trained machine learning model for determining values of parameters associated with a patient's heart, according to some embodiments.

FIG. 14 shows a computer system, according to some embodiments.

### DETAILED DESCRIPTION

The invention will be more particularly elucidated below without distinguishing between the subjects of the invention (method, computer system, computer readable storage medium). On the contrary, the following elucidations are intended to apply analogously to all the subjects of the invention, irrespective of in which context (method, computer system, storage medium) they occur.

The present invention provides tools for training a machine learning model to perform a task on one or more images.

The term “image” as used herein means a data structure that represents a spatial distribution of a physical signal. The spatial distribution may be of any dimension, for example 2D, 3D, or 4D. The spatial distribution may be of any shape. For example, if a grid associated with the spatial distribution is formed to define pixels, the grid may be irregular or regular. The physical signal may be any signal, for example color, level of gray, depth, surface occupancy, or volume occupancy, such that the image may be a 2D or 3D RGB/grayscale/depth image, or a 3D surface/volume occupancy model. The image may be a synthetic image, such as a designed 3D modeled object, or alternatively a natural image, such as a photo or frame from a video.

In a preferred embodiment of the present invention, an is a medical image. A medical image is a visual representation of the human body or a part thereof or a visual representation of the body of an animal or a part thereof. Medical images can be used, e.g., for diagnostic and/or treatment purposes.

Techniques for generating medical images include X-ray radiography, computerized tomography, fluoroscopy, magnetic resonance imaging, ultrasonography, endoscopy, elastography, tactile imaging, thermography, microscopy, positron emission tomography and others.

Examples of medical images include CT (computer tomography) scans, X-ray images, MRI (magnetic resonance imaging) scans, fluorescein angiography images, OCT (optical coherence tomography) scans, histopathological images, ultrasound images.

The machine learning model of the present invention is trained to perform a task on one or more images.

In a preferred embodiment, the task to be performed on the at least one image is a classification task. In such a classification task, an image is classified into one of a number of classes. Usually, a class relates to one or more features of the image, e.g., to what is shown in the image.

The following example of a classification task is provided solely for illustrative purposes. Images may be CT scans of the thoraxes of a multitude of subjects. A portion of the subjects suffer from a certain disease, such as chronic thromboembolic pulmonary hypertension (CTEPH); the other subjects are healthy. An example of a classification task is the classification of each image (CT scan) into one of two classes, a first class containing the images of subjects suffering from CTEPH, a second class containing the images of subjects being healthy.

The present invention is not restricted to classification tasks. The task to be performed on one or more images can also be a regression task, an image quality enhancement task, a segmentation task, a reconstruction task, or any other task or combination of tasks.

Examples of a task to be performed by the task performing agent include:
detection of lesions or tumor cells in whole slide images (see, e.g., G. Campanella et al.: Clinical-grade computational pathology using weakly supervised deep learning on whole slide images, Nat Med 25, 1301-1309 (2019), https://doi.org/10.1038/s41591-019-0508-1; PCT/EP2020/061665);
detection of pneumonia from chest X-rays (see, e.g., CheXNet: Radiologist-Level Pneumonia Detection on Chest X-Rays with Deep Learning; arXiv:1711.05225);
detection of acute respiratory distress syndrome (ARDS) in intensive care patients (see, e.g., EP-A 20151108.6);
predicting response of a patient to a specific therapy (see, e.g., U.S. Ser. No. 10/943,348B2, EP-A 20207292.2).

The task to be performed on one or more images is performed by a task performing agent. The task performing agent comprises an input for receiving the one or more images, a processing unit for performing the task on each received image, and an output for outputting a result such as, for example, a classification result, a regression result, a segmented image, a quality-improved image, a reconstructed image and/or the like.

The task performing agent can be or comprise an artificial neural network. Artificial neural networks are biologically-inspired computational networks. Artificial neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

In particular, in the case of a classification task to be performed, the task performing agent can, e.g., be or comprise a convolutional neural network (CNN).

A CNN is a class of deep neural networks most commonly applied to analyzing visual imagery. A CNN comprises an input layer with input neurons, an output layer with at least one output neuron, as well as multiple hidden layers between the input layer and the output layer.

The hidden layers of a CNN typically comprise convolutional layers, ReLU (Rectified Linear Units), i.e., activation function, layers, pooling layers, fully connected layers, and normalization layers.

The nodes in the CNN input layer can be organized into a set of “filters” (feature detectors), and the output of each set of filters is propagated to nodes in successive layers of the network. The computations for a CNN include applying the mathematical convolution operation with each filter to produce the output of that filter. Convolution is a specialized kind of mathematical operation performed with two functions to produce a third function. In convolutional network terminology, the first function of the convolution can be referred to as the input, while the second function can be referred to as the convolution kernel. The output may be referred to as the feature map. For example, the input of a convolution layer can be a multidimensional array of data that defines the various color or greyscale components of an input image. The convolution kernel can be a multidimensional array of parameters, where the parameters are adapted by the training process for the neural network.

The objective of the convolution operation is to extract features (such as, e.g., edges from an input image). Conventionally, the first convolutional layer is responsible for capturing the low-level features such as edges, color, gradient orientation, etc. With added layers, the architecture adapts to the high-level features as well, giving a network which has the wholesome understanding of images in the dataset. Similar to the convolutional layer, the pooling layer is responsible for reducing the spatial size of the feature maps. It is useful for extracting dominant features with some degree of rotational and positional invariance, thus maintaining the process of effectively training of the model. Adding a fully-connected layer is a way of learning non-linear combinations of the high-level features as represented by the output of the convolutional part.

More details about convolutional neural networks can be found in various publications (see, e.g., Yu Han Liu: Feature Extraction and Image Recognition with Convolutional Neural Networks, 2018, J. Phys.: Conf Ser. 1087 062032; H. H. Aghdam et al.: Guide to Convolutional Neural Networks, Springer 2017, ISBN: 978-3-319-57549-0; S. Khan et al.: Convolutional Neural Networks for Computer Vision, Morgan & Claypool Publishers, 2018, ISBN: 978-1-681-730219).

Very often, for a task to be performed, it is not necessary to feed the whole image to the task performing agent. Very often, it is sufficient to focus on one or more areas of an image to perform a task. To stick to the CTEPH example mentioned above: for the classification of CT scans into two classes, one class containing CT scans of subjects suffering from CTEPH, the other class containing CT scans of healthy subjects, it is not necessary to analyze CT scans of the full thorax of the subjects but it is sufficient to focus on the heart and the lungs (see e.g. WO2018/202541).

Better results may be achieved when the task is performed only on a part or on parts of an image. In other cases, bringing out (e.g., highlighting or accentuating) one or more features of an image before the task is performed so that the task performing agent focusses on the one or more highlighted features may be beneficial and may achieve better results.

In some cases, a user may be interested in knowing the aspects/features of an image on which the task performing agent is focusing when it performs the task, e.g., in order to uncover a systematic error.

In order to focus on relevant aspects of an image and/or in order to make visible the aspects/features on which the task performing agent is focusing when performing the task, a transformation agent is used. Specifically, before an image is fed to the task performing agent, it is fed to the transformation agent. The transformation agent is configured to receive an image, to apply one or more image transformations to the received image, and to output a transformed image. The transformed image is then fed to the task performing agent. In other words: the task is not performed on the (original) image but on a transformed image, and the task performing agent is trained to find an optimal or nearly optimal transformation which leads to an optimal or nearly optimal result of the task performed on the image.

Image transformations include, but are not limited to: dilation, shear, translation, scaling, homothety, reflection, rotation, shear mapping, elastic deformation, flipping, scaling, stretching, cropping, resizing, filtering, masking, Fourier transformation, discrete cosine transformation and compositions of them in any combination and sequence.

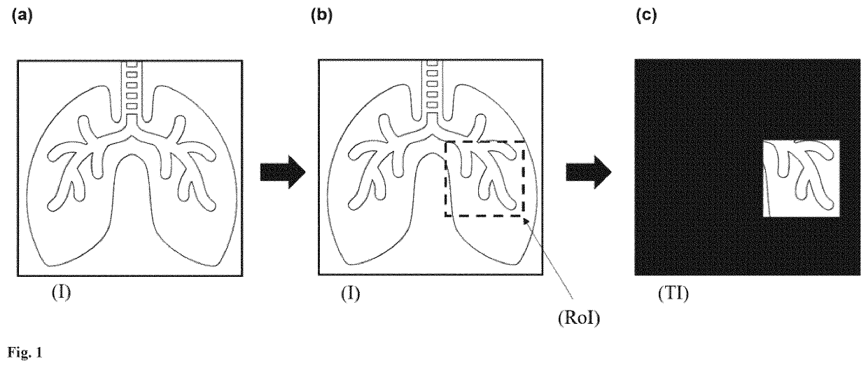

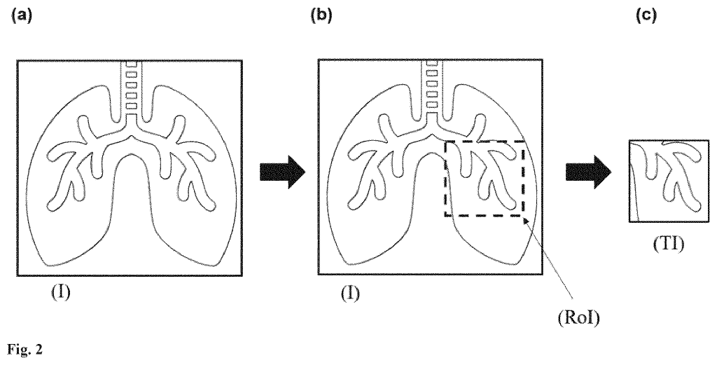

In a preferred embodiment the image transformation includes the selection of a region of interest within the image. The selection of a region of interest results in a transformed image which is either reduced to the region of interest (e.g., by cropping) or masked. This is schematically shown by way of example in FIG. 1 and FIG. 2.

FIG. 1 shows schematically an example of a masking operation on an image. FIG. 1(a) shows schematically an image (I) of the lungs of a subject. In FIG. 1(b) a part of the image is highlighted by a dashed rectangle. The area within the dashed rectangle is the region of interest (RoI). In FIG. 1(c) the color values of all pixels of the image (I) outside the region of interest (RoI) are set to zero (black). The resulting image (TI) is a masked image (a transformed image) which can be fed to the task performing agent.

FIG. 2 shows schematically an example of a cropping operation on an image. FIG. 2(a) shows schematically an image (I) of the lungs of a subject. In FIG. 2(b) a part of the image is highlighted by a dashed rectangle. The area within the dashed rectangle is the region of interest (RoI). FIG. 2(c) shows a cropped image (TI): all areas of the former image (I) which do not belong to the region of interested are cut away. The cropped image (TI) is a transformed image which can be fed to the task performing agent.

The region of interest can be a two-dimensional area (e.g., in case of 2D images) or three-dimensional area (e.g., in case of 3D images) or a higher dimensional area.

In case of a 2D image, the region of interest is preferably a two-dimensional area within the image. In case of a 3D image, the region of interest is preferably a three-dimensional volume within the image. However, it is also possible that the dimension of the area is not initially defined but a variable transformation parameter which is learned by the machine learning model in the training phase.

It is possible that there is more than one region of interest, e.g., two, three, four, or, more generally, N regions of interest, with N being an integer greater than 0.

The one or more image transformations performed by the transformation agent are based, at least in part, on a set of transformation parameters. The values of the transformation parameters define what the transformation agent will do with an inputted image. The aim of the training can be to find optimal (or nearly optimal) transformation parameters which lead to an optimal (or nearly optimal) result of the task performed by the task performing agent.

In case of the selection of a region of interest, transformation parameters can include, e.g., the size of the region of interest, the location of the region of interest within the image, the shape of the region of interest and/or others.

Some transformation parameters may be fixed parameters and others may be variable parameters. It is possible that all parameters defining a transformation are variable parameters; it is even possible that the type of transformation is a (variable) transformation parameter. However, there is at least one transformation parameter which is variable. This is essential since the machine learning model is trained to optimize one or more variable transformation parameters to improve the result of the task to be performed by the task performing agent (see more details below).

In case of the selection of a region of interest, the shape of the region of interest may be a fixed parameter and the size and/or the location (within the image) may be variable parameters.

The (fixed) shape of the region of interest may by a rectangle, square, triangle, trapeze, circle, ellipse, cube, cuboid, cylinder, ellipsoid, sphere or any other shape or combinations of shapes.

Prior knowledge about the shape of an object in an image can be used to define the shape of the region of interest (see, e.g., N. Vu, B. S. Manjunath: Shape prior segmentation of multiple objects with graph cuts, 2008 IEEE Conference on Computer Vision and Pattern Recognition, doi: 10.1109/CVPR.2008.4587450; J. Liu et al.: Convex Shape Prior for Deep Neural Convolution Network based Eye Fundus Images Segmentation; arXiv:2005.07476 [cs.CV]; A. M. Quispe, C. Petitjean: Shape prior based image segmentation using manifold learning, 2015 International Conference on Image Processing Theory, Tools and Applications (IPTA), 2015, pp. 137-142, doi: 10.1109/IPTA.2015.7367113).

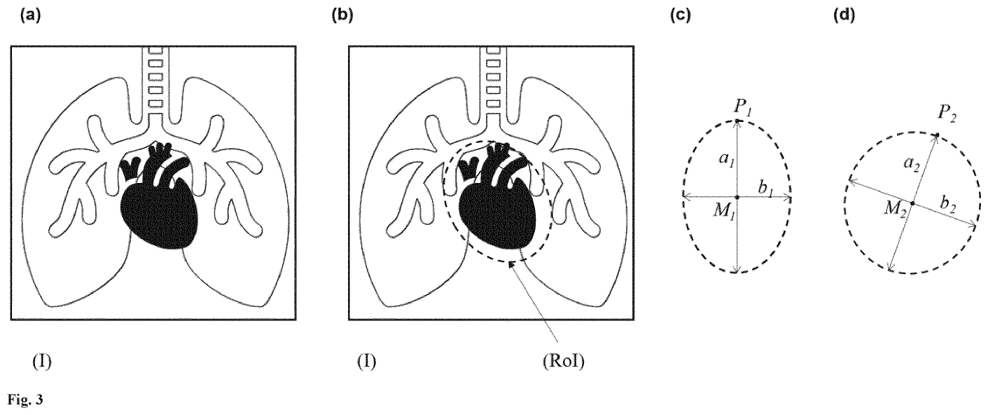

FIG. 3 shows schematically examples of variable and fixed transformation parameters for the selection of a region of interest. FIG. 3(a) shows schematically an image (I) of the lungs and the heart of a subject. In FIG. 3(b) a part of the image is highlighted by a dashed ellipse. The area within the dashed ellipse is the region of interest (RoI). The region of interest (RoI) contains the heart. In FIG. 3(b) the region of interest has the shape of an ellipse. An ellipse can be fully described by, e.g., two mutually perpendicular axes a and b, and the location of two points of the ellipse within the image, e.g., the point M of intersection of the two axes a and b, and the point P on the perimeter of the ellipse. The elliptical shape of the region of interest is an example of a fixed transformation parameter. The length of the axis a, the length of the axis b, the coordinates of the point M within the image and the coordinates of the point P within the image are examples of variable transformation parameters. FIG. 3(c) and FIG. 3(d) show two examples of elliptical regions of interest being characterized by different values of variable transformation parameters; the values are a1, b1, M1 and P1 in case of the region of interest shown in FIG. 3(c) and a2, b2, M2 and P2 in case of the region on interest shown in FIG. 3(d).

It is possible to define for one or more of the variable transformation parameters a range of allowed values. It is possible to define an upper and a lower limit (value). To come back to the example of FIG. 3: the size of the hearts of human beings varies; the heart of a child is smaller than the heart of an adult. However, the heart of a human being cannot be of any size. There is a reasonable lower and a reasonable upper limit. The knowledge about the size of an object depicted in an image can be used to define a range of allowable values for variable transformation parameters.

There can be further constraints, e.g., that the region of interest must not reach beyond the boundaries of the image.

Irrespective of any constraints and/or fixed transformation parameters, there is a defined range of allowable values for the variable transformation parameters, and the aim is to find, for each image fed into the transformation agent, the values for the transformation parameters which lead to an optimized result of the task performed by the task performing agent. The process for finding these values is described in more detail below.

Any prior knowledge about an image, about the content of the image, and about aspects of the image that are important for performing the task by the task performing agent can be used to define fixed transformation parameters and/or allowable values of variable transformation parameters. The definition of fixed transformation parameters and/or allowable values of variable transformation parameters means that the transformation agent is not able to perform a transformation which is not in line with said definition. In other word, if the shape of a region of interest is defined as a rectangle (fixed transformation parameter), the transformation agent is not able to select a region of interest of elliptical shape; if the allowed upper value of a variable transformation parameter is 100, the transformation agent is not able to perform a transformation on an image in which the value of the respective transformation parameter is 101. Such constraints (fixed transformation parameters and/or allowed ranges of values of variable transformation parameters) are referred to as hard constraints hereinafter.

The transformation agent can be flexible with respect to the choice of transformations and/or values of transformation parameters. For example, transformations and/or values of transformation parameters may be allowed which, at a first glance, do not seem reasonable.

It is possible to allow any kind of transformations and to train the transformation agent to learn the transformation which, for a given image, leads to an optimized (preferably the best) result of the task performed by the task performance agent.

For the selection of one or more regions of interest it is also possible to allow the transformation agent to set the (grey or color) values of a certain number or an arbitrary (random) number of pixels/voxels to zero. It is also possible to allow the transformation agent to set the (grey or color) values of one or more groups of (contiguous) pixels/voxels to zero. The transformation agent is then trained to find, for a given image, an optimal transformation which leads to an optimized (preferably the best) result of the task performed by the task performance agent.

The transformation agent can be or comprise an artificial neural network which is trained to find, for a given image, an optimal transformation. In a preferred embodiment, the transformation agent is or comprises an architecture like the U-net which is configured to receive an image and outputs a transformed image (see, e.g., O. Ronneberger et al.: U-net: Convolutional networks for biomedical image segmentation, arXiv:1505.04597, 2015). Skip connections may be present between the encoder and the decoder (see, e.g., Z. Zhou et al.: Model Genesis, arXiv:2004.07882).

Once the transformed image is generated by the transformation agent, it can be fed to the task performing agent which performs one or more tasks on the transformed image.

For each task performed by the task performing agent, a task performance loss is computed. The task performance loss is a score indicating the quality and/or accuracy of the result of the task (a kind of performance indicator). The task performance loss is a score which quantifies how far the result of the task is from a predefined target.

Depending on the task performed by the task performance agent, the task performance loss can be computed via a variety of loss functions. Some examples of loss functions are given hereinafter:
Regression Loss Functions: Mean Squared Error Loss, Mean Squared Logarithmic Error Loss, Mean Absolute Error Loss
Binary Classification Loss Functions: Binary Cross-Entropy, Hinge Loss, Squared Hinge Loss
Multi-Class Classification Loss Functions: Multi-Class Cross-Entropy Loss, Sparse Multiclass Cross-Entropy Loss, Kullback Leibler Divergence Loss

The task performance loss can be used to guide the transformation agent in finding an optimal transformation which leads to an optimized result of the task performed by the task performing agent.

In a preferred embodiment of the present invention, the transformation agent is a reinforcement learning agent of a machine learning system.

In general, reinforcement learning (RL) is an area of machine learning concerned with how intelligent agents ought to take actions in an environment in order to maximize the notion of cumulative reward. In other words: the purpose of reinforcement learning is for the agent to learn an optimal, or nearly-optimal (e.g., optimized) policy that maximizes a reward function or other user-provided reinforcement signal that accumulates from the immediate rewards.

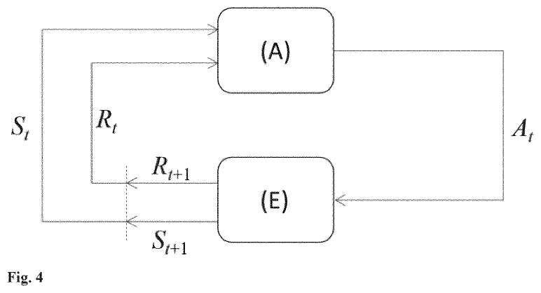

An example of a basic RL process is schematically depicted in FIG. 4. According to FIG. 4, a reinforcement learning agent (A) interacts with its environment (E) in discrete steps. At each step t, the agent receives the current state St and reward Rt. It then chooses an action At from a set of available actions, which is subsequently sent to the environment E. The environment E moves to a new state St+1 and the reward Rt+1 associated with the transition (St, At, St+1) is determined. The goal of a reinforcement learning agent is to learn a policy which maximizes the expected cumulative reward.

A policy defines the learning agent's way of behaving at a given time. Roughly speaking, a policy is a mapping from perceived states of the environment to actions to be taken when in those states.

A reward signal defines the goal in a reinforcement learning problem. On each step, the environment sends to the reinforcement learning agent a single number, the reward. The agent's sole objective is to maximize the total reward it receives over the long run. The reward sent to the agent at any time (step) depends on the agent's current action and the current state of the agent's environment. The agent cannot alter the process that does this. The only way the agent can influence the reward signal is through its actions, which can have a direct effect on reward, or an indirect effect through changing the environment's state. If an action selected by the policy is followed by low reward, then the policy may be changed to select some other action in that situation in the future. In general, reward signals may be stochastic functions of the state of the environment and the actions taken.

Applied to the present invention, this means: the agent is the transformation agent which performs a transformation of an image. A task is performed on the transformed image, and a reward is computed for the result of the task. The reward is provided to the agent which learns to select transformations on images which lead to a maximum reward.

Whereas the reward signal indicates what is good in an immediate sense, a value function specifies what is good in the long run. Roughly speaking, the value of a state is the total amount of reward an agent can expect to accumulate over the future, starting from that state.

Unfortunately, it is much harder to determine values than it is to determine rewards. Rewards may be given directly by the environment, but values must be estimated and re-estimated from the sequences of observations an agent makes over its entire lifetime.

In a preferred embodiment, an actor-critic reinforcement learning system is used to train the machine learning model according to the present invention. An actor-critic system comprises an actor and a critic. The actor takes as input the state and outputs the best action. It may control how the agent behaves by learning the optimal policy (policy-based). The critic, on the other hand, evaluates the action by computing the value function (value-based).

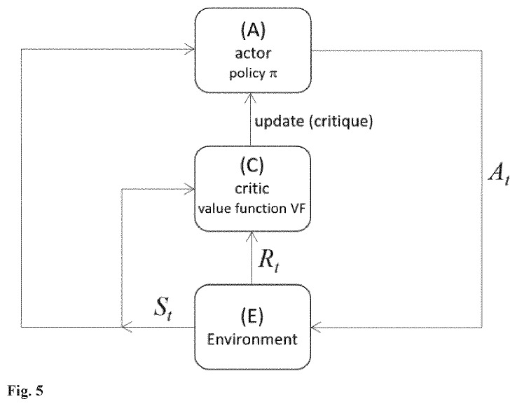

FIG. 5 shows schematically an actor-critic reinforcement learning approach. The actor (A) is responsible for choosing an action in a given state of the environment (E) according to a policy π, and the critic (C) observes the outcomes and rewards caused by the chosen actions and critiques them accordingly. If the critique is positive, then the probability of the actor choosing the same action in the same state in future is increased and vice versa.

Details about (actor-critic) reinforcement learning can be found in various publications (see, e.g.: I. Grondman et al.: A Survey of Actor-Critic Reinforcement Learning: Standard and Natural Policy Gradients, 2012, IEEE Transactions on Systems Man and Cybernetics Part B-Cybernetics. 42. 1291-1307. 10.1109/TSMCC.2012.2218595; V. R. Konda, J. Tsitsiklis: Actor-Critic Algorithms, SIAM Journal on Control and Optimization, MIT Press, 2000, pages 1008-1014; V. R. Konda, J. Tsitsiklis: On Actor-Critic Algorithms, SIAM J. Control Optim. Vol. 42, No. 4, pp. 1143-1166; EP3593294; EP3698291; US20200293862; EP3326114; EP3696737; US20200143206; WO2020/146356; WO2018/164716).

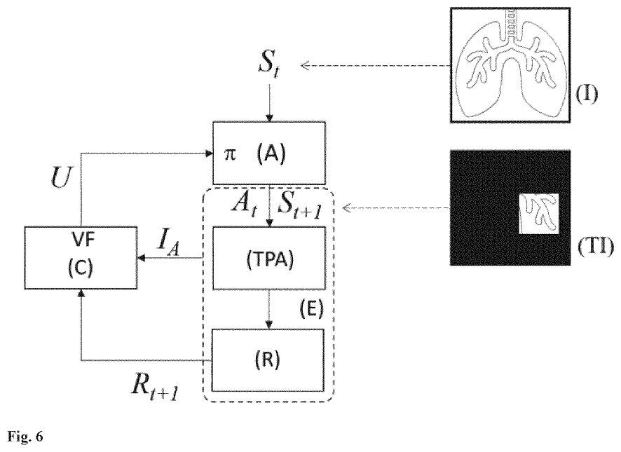

FIG. 6 shows an example of an actor-critic reinforcement learning approach according to the present invention as a flow chart. The actor-critic reinforcement learning process starts with a state St. The state St is an image (I). The actor (A) selects an action according to a policy π and takes the selected action At. The action At comprises one or more transformations of the image (I). The result of the transformation action is a transformed image (TI). The transformed image (TI) constitutes a new state St+1. The transformed image (TI) is fed to a task performing agent (TPA). The task performing agent (TPA) is configured to perform a task on the transformed image (TI). The outcome of the task performed by the task performing agent (TPA) is a result (R). For the result (R) a reward Rt+1 is computed. The reward Rt+1 is fed to the critic (C). In addition, the critic (C) receives information IA about the action At performed by the actor (A) and/or the state St+1 of the environment (E) as a result of the action At. The received information IA can, e.g., be the image (I) and the transformed image (TI). The critic (C) is configured to define, on the basis of the received information, a value function VF. The value function VF is used to provide the actor with a critique U about the impact of the action on the environment, or, to be more precisely, about the impact of the selected transformation(s) on the quality/accuracy of the result (R). The critique U is used to update the policy π.

After the cycle has been completed, a new image (I) is received by the actor (A), and a new cycle starts. In the training phase, the machine learning model is fed with a multitude of images. The term multitude means a number of images which is greater than 10, usually greater than 100, preferably greater than 1000.

Each image and each cycle lead to the fact that the machine learning model generates better results over time.

In a preferred embodiment, the actor and the critic are or comprise an artificial neural network.

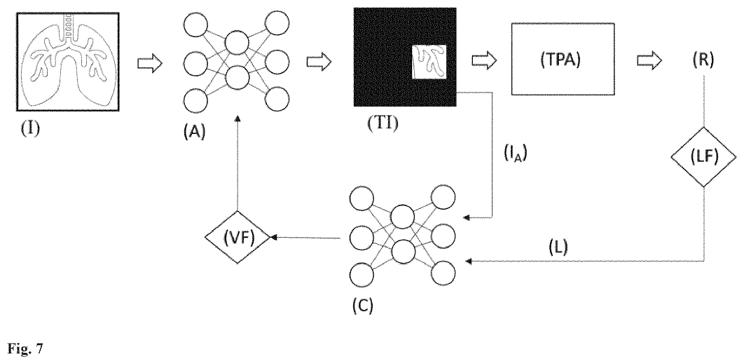

FIG. 7 shows schematically by way of another example, how an actor-critic reinforcement learning approach can be used in order to train the machine learning model of the present invention to perform a task on an image. An image (I) is fed to an actor (A). The actor (A) selects an action to be performed on the received image (I) in accordance with a policy. The action comprises one or more transformations of the image. The result of the one or more transformations is a transformed image (TI) which is fed to a task performing agent (TPA). The task performing agent (TPA) is configured to perform a task on the transformed image (TI). For the result (R) of the task performed by the task performing agent (TPA), a task performance loss (L) is calculated using a loss function (LF). The task performance loss (L) and information (IA) about the one or more transformations applied to the image (I) (such as the image (I) and the transformed image (TI)) are fed to a critic (C). The critic (C) is trained to define a value function (VF). The value function is used to update the policy of the agent (A).

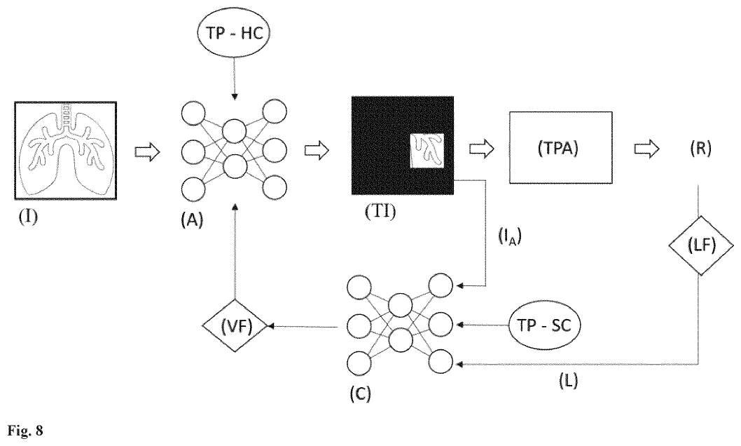

FIG. 8 shows schematically a variant of the actor-critic reinforcement learning approach as depicted in FIG. 7. In addition to the elements described in relation to FIG. 7, there are hard constraints (TP-HC) with regard to the transformation parameters (TP) and soft constraints (TP-SC) with regard to the transformation parameters. The hard constraints (TP-HC) are implemented in the actor. The actor is not able to select an action which does not fulfill the hard constraints. As already explained above, the actor can, e.g., not select a region of interest with an elliptical shape if, for example, according to the hard constraints (TP-HC) the region of interest must have a rectangular shape. The soft constraints (TP-SC) are implemented in the critic. By doing so, the actor can select an action which does not fulfill the soft constraints (TP-SC), but the actor will be punished or will get less reward in case the actor selects an action which does not fulfill the soft constraints (TP-SC). In case of implementation of constraints as soft constraints, the actor is much more flexible and can select actions which seem to be unreasonable but might be successful (on a long run).

In a preferred embodiment of the present invention, the transformed image is outputted by an output unit, e.g., the transformed image is displayed on a display, printed by a printer and/or stored in a storage unit. The outputted transformed image can be examined by an expert. The expert can determine on the basis of the outputted image, on which features/aspects of an image the result of the task performed by the task performing agent is based. In other words: the outputted transformed image shows the expert on which features/aspects of an image the task performing agent focusses when performing the task. Such information can be, e.g., used to identify systematic errors and/or to learn what aspects/features of an image are important aspects/features for performing the task.

As already mentioned, the task performing agent can be a machine learning model, which is trained to perform one or more tasks on a (transformed) image using machine learning techniques such as supervised learning, unsupervised learning or reinforcement learning. If the task performing agent is a machine learning model which needs to be trained to perform one or more tasks on the (transformed) image, the whole architecture as depicted in FIG. 7 and FIG. 8 comprising the actor, the critic, and the task performing agent can be trained in a combined training (end-to-end). However, it is also possible to pre-train, e.g., the task performing agent, and then use the pre-trained task performing agent to train the actor-critic network system, and then, optionally, do a final (combined) training of all components.

The trained machine learning model can be stored on a data storage, outputted, and/or used for performing a task on an image.

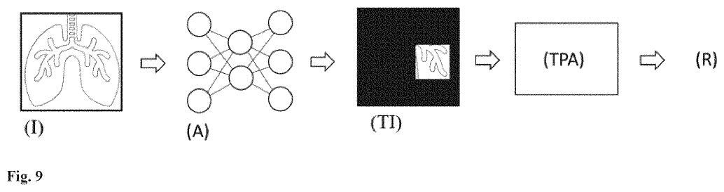

Once the value function has been generated and the results obtained by the task performing agent have achieved a pre-defined quality (e.g., accuracy), the critic can be removed, and the trained machine learning model can be used for performing tasks on (new) images. This is schematically shown in FIG. 9. The remaining trained machine learning model for performing a task on an image (I) consists of the trained transformation agent (A) (e.g., the former actor), and the task performing agent (TPA). The trained transformation agent (A) receives an image (I) and applies one or more transformations to the image (I). The resulting transformed image (TI) is fed to the task performing agent (TPA) which performs a task. The result (R) of the task is outputted.

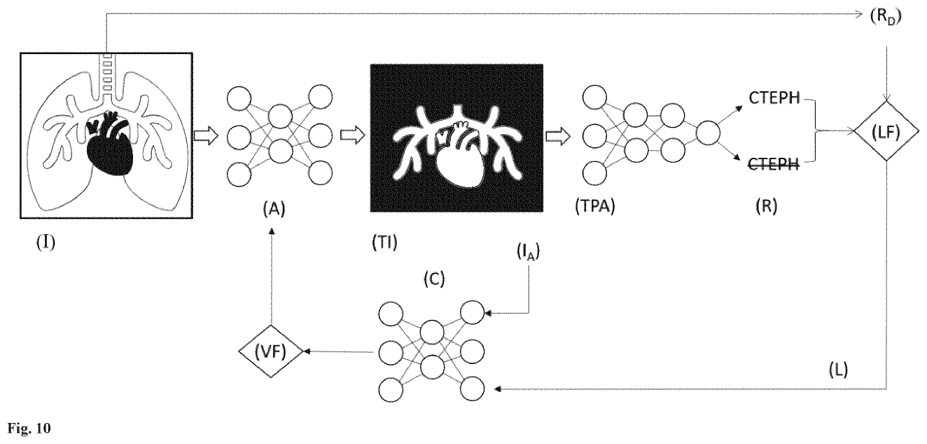

FIG. 10 shows schematically one example of a machine learning model according to the present invention and how it is trained to perform a certain task. The task shown in FIG. 10 is the classification of a subject patient into one of two classes, one class containing patients which suffer from CTEPH, the other class containing healthy patients. The classification is based on one or more images (I) of the thorax of the subject patient.

The machine learning model comprises an actor (A), a critic (C), and a task performing agent (TPA). The machine learning model is trained on the basis of a training set, the training set comprising a multitude of labeled images from persons either suffering from CTEPH or being healthy. So, for each image of the multitude of images it is known whether the image shows the thorax of a person suffering from CTEPH or whether the image shows the thorax of a healthy person. This label information is referred to as (RD) in FIG. 10. The actor (A) is configured to receive one or more images (I), and to apply one or more transformations to the one or more images (I) in accordance with a policy. The result of the one or more transformations is/are one or more transformed images (TI). The one or more transformed images (TI) are fed to the task performance agent (TPA) which is configured to classify the one or more transformed images (TI) into one of two classes, a first class containing images of persons suffering from CTEPH, a second class containing images of healthy persons (persons not suffering from CTEPH=CTEPH). The classification result (R) is compared with the label information (RD) and a classification loss (L) is computed using a classification loss function (LF). The classification loss (L) is fed to the critic. Additionally, information (IA) about the one or more transformations applied to the one or more images (I) (such as the one or more images and the one or more transformed images) are fed to the critic (C). The critic is configured to provide a critique to the actor (A) on the basis of a value function (VF).

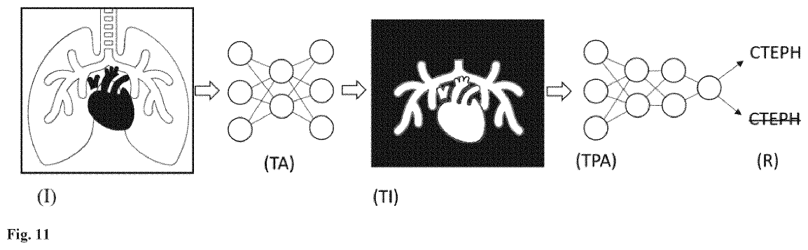

Once the machine learning model is trained on the basis of a multitude of images, and the classification loss has achieved a pre-defined range or threshold, the machine learning model can be reduced to the components shown in FIG. 11. FIG. 11 shows the trained machine learning model which can be used for classification of a (new) subject patient on the basis of an image (I). The machine learning model comprises a transformation agent (TA) which is the trained actor (A) of FIG. 10. The transformation agent (TA) is configured to receive one or more images (I), and to transform the one or more images into one or more transformed images (TI) which is/are fed to a task performing agent (TPA) which performs the task of classifying the subject patient, on the basis of the one or more transformed images (TI), into one of two classes, a first class containing images of persons suffering from CTEPH, a second class containing images of healthy persons.

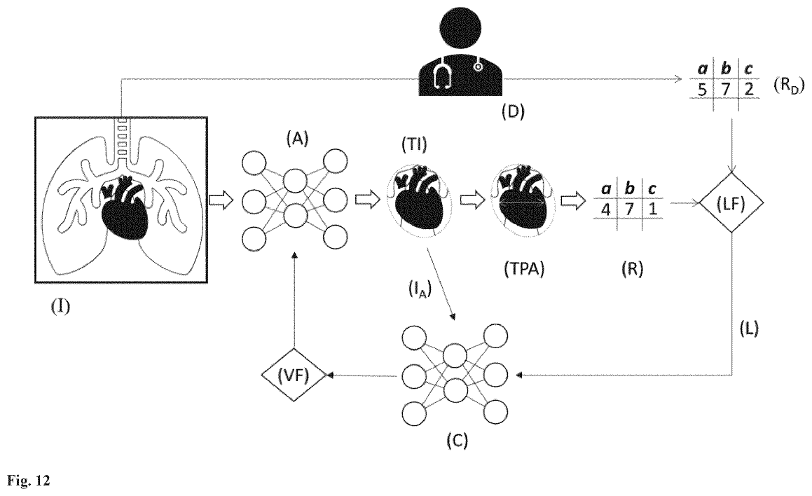

FIG. 12 shows schematically another example of a machine learning model according to the present invention and how it is trained to perform a certain task. The task shown in FIG. 12 is the determination of the values of some parameters a, b, and c of the heart of a patient. Such parameters can be, e.g., the volume of the left ventricle, the radius of the left ventricle, the radius of the right ventricle, the volume of the right ventricle, the volume of the pulmonary aorta, the radius of the pulmonary aorta, the volume of the ascending aorta, the radius of the ascending aorta and/or others. These parameters can, e.g., be used to assess the likelihood of a subject patient suffering from CTEPH (see, e.g., WO2018/202541, WO2020185758A1, EP-A 20202165.5 for more details).

It is possible that the task performing agent (TPA) is a machine learning system which has been pre-trained to automatically determine such parameters from images. The aim of the reinforcement learning approach can be to achieve better results in automatically determining the heart parameters by reducing the images to a region of interest which comprises the heart but mainly excludes other parts of the human body. In the training process, a multitude of images is received. Each image (I) is fed to the actor which is configured to select and perform a transformation based, at least in part, on a set of transformation parameters to each image (I). The image (I) is transformed, and the transformed image (TI) is fed to the task performing agent (TPA) which is configured to determine values of the heart parameters a, b, and c from the transformed image (TI). The values of the heart parameters a, b, and c are the result of the task performed by the task performing agent (TPA). In a next step, a loss (L) is calculated by means of a loss function (LF), the loss indicating how accurate the result (R) is. The result (R) can, e.g., be compared with the result (RD) determined by an expert (D). The loss (L) is fed to a critic. Additionally, the critic receives information (IA) about the transformation performed by the actor (A). The critic is configured to define a value function (VF). The value function is used to provide feedback to the actor (A).

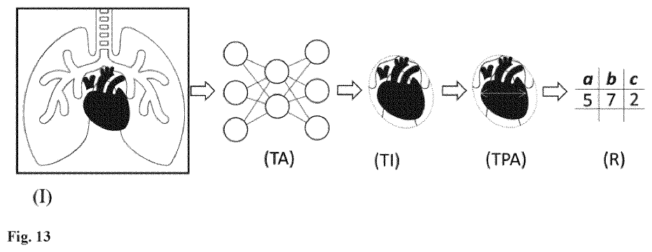

Once the machine learning model is trained on the basis of a multitude of images, and the loss has achieved a pre-defined range or threshold, the machine learning model can be reduced to the components shown in FIG. 13. FIG. 13 shows the trained machine learning model for determining values of heart parameters a, b, and c, on the basis of an image (I). The machine learning model comprises a transformation agent (TA) which is the trained actor (A) of FIG. 12. The transformation agent (TA) is configured to receive an image (I), and to transform the image into a transformed image (TI) which is fed to a task performing agent which performs the task of determining values of the heart parameters a, b, and c on the basis of the transformed image (TI).

The operations in accordance with the teachings herein may be performed by at least one computer specially constructed for the desired purposes or general-purpose computer specially configured for the desired purpose by at least one computer program stored in a typically non-transitory computer readable storage medium.

The term “non-transitory” is used herein to exclude transitory, propagating signals or waves, but to otherwise include any volatile or non-volatile computer memory technology suitable to the application.

The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices.

The term “process” as used herein is intended to include any type of computation or manipulation or transformation of data represented as physical, e.g., electronic, phenomena which may occur or reside, e.g., within registers and/or memories of at least one computer or processor. The term processor includes a single processing unit or a plurality of distributed or remote such units.

Any suitable input device, such as but not limited to a keyboard, a mouse, a microphone and/or a camera sensor, may be used to generate or otherwise provide information received by the system and methods shown and described herein. Any suitable output device or display, such as but not limited to a computer screen (monitor) and/or printer may be used to display or output information generated by the system and methods shown and described herein. Any suitable processor/s, such as bot not limited to a CPU, DSP, FPGA and/or ASIC, may be employed to compute or generate information as described herein and/or to perform functionalities described herein. Any suitable computerized data storage, such as but not limited to optical disks, CDROMs, DVDs, BluRays, magnetic-optical discs or other discs; RAMs, ROMs, EPROMs, EEPROMs, magnetic or optical or other cards, may be used to store information received by or generated by the systems shown and described herein. Functionalities shown and described herein may be divided between a server computer and a plurality of client computers. These or any other computerized components shown and described herein may communicate between themselves via a suitable computer network.

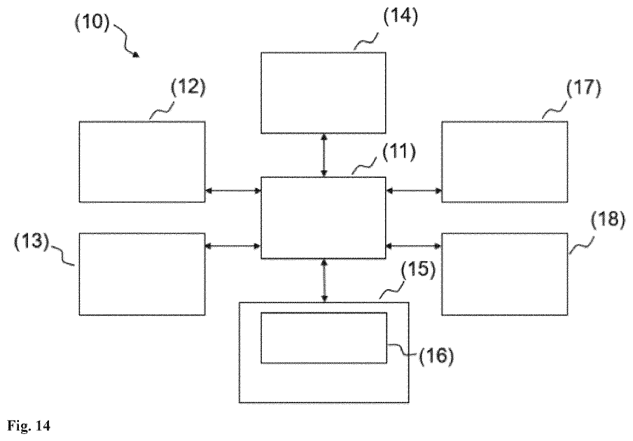

FIG. 14 illustrates a computer system (10) according to some example implementations of the present invention in more detail. Generally, a computer system of exemplary implementations of the present disclosure may be referred to as a computer and may comprise, include, or be embodied in one or more fixed or portable electronic devices. The computer may include one or more of each of a number of components such as, for example, processing unit (11) connected to a memory (15) (e.g., storage device).

The processing unit (11) may be composed of one or more processors alone or in combination with one or more memories. The processing unit is generally any piece of computer hardware that is capable of processing information such as, for example, data (incl. digital images), computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit (11) may be configured to execute computer programs, which may be stored onboard the processing unit or otherwise stored in the memory (15) of the same or another computer.

The processing unit (11) may be a number of processors, a multi-core processor or some other type of processor, depending on the particular implementation. Further, the processing unit may be implemented using a number of heterogeneous processor systems in which a main processor is present with one or more secondary processors on a single chip. As another illustrative example, the processing unit may be a symmetric multi-processor system containing multiple processors of the same type. In yet another example, the processing unit may be embodied as or otherwise include one or more ASICs, FPGAs or the like. Thus, although the processing unit may be capable of executing a computer program to perform one or more functions, the processing unit of various examples may be capable of performing one or more functions without the aid of a computer program. In either instance, the processing unit may be appropriately programmed to perform functions or operations according to example implementations of the present disclosure.

The memory (15) is generally any piece of computer hardware that is capable of storing information such as, for example, data, computer programs (e.g., computer-readable program code (16)) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD, Blu-ray disk or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory (15), the processing unit (11) may also be connected to one or more interfaces (12, 13, 14, 17, 18) for displaying, transmitting and/or receiving information. The interfaces may include one or more communications interfaces (17, 18) and/or one or more user interfaces (12, 13, 14). The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) to connect to a network, such as using technologies such as cellular telephone, Wi-Fi, satellite, cable, digital subscriber line (DSL), fiber optics and the like. In some examples, the communications interface(s) may include one or more short-range communications interfaces configured to connect devices using short-range communications technologies such as NFC, RFID, Bluetooth, Bluetooth LE, ZigBee, infrared (e.g., IrDA) or the like.

The user interfaces (12, 13, 14) may include a display (14). The display (14) may be configured to present or otherwise display information to a user, suitable examples of which include a liquid crystal display (LCD), light-emitting diode display (LED), plasma display panel (PDP) or the like. The user input interface(s) (12, 13) may be wired or wireless, and may be configured to receive information from a user into the computer system (10), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded, and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

1: A computer-implemented method of training a machine learning model comprising a transformation agent and a task performing agent to perform a task based on an image the method comprising:
receiving a training set comprising a multitude of images;
feeding each image of the training set to the transformation agent, wherein the transformation agent is configured to apply one or more image transformations to each image based, at least in part, on a set of transformation parameters;
feeding each transformed image to the task performing agent, wherein the task performing agent is configured to perform a task on each transformed image;
determining, for each task performed by the task performing agent, a task performance loss; and
training the transformation agent to optimize the set of transformation parameters, based, at least in part, on minimizing the task performance loss.

2: The method of claim 1, further comprising:
storing the trained machine learning model and/or outputting the trained machine learning model and/or using the trained machine learning model to perform a task on an image.

3: The method of claim 1, further comprising:
outputting one or more transformed images.

4: The method of claim 1, wherein the transformation agent is a reinforcement learning agent.

5: The method of claim 1, further comprising:
providing a machine learning system, the machine learning system comprising an actor, and a critic,
wherein the actor is configured to select, for each image received, based on a policy, the one or more image transformations,
wherein the critic is configured to:
receive the task performance loss and information about the one or more image transformations selected by the actor;
define a value function based on the task performance loss and the information about the one or more image transformations; and
update the policy of the actor based on the value function.

6: The method of claim 1, wherein the one or more image transformations comprises: dilation, shear, translation, scaling, homothety, reflection, rotation, shear mapping, elastic deformation, flipping, scaling, stretching, cropping, resizing, filtering, masking, Fourier transformation, discrete cosine transformation, or combinations thereof.

7: The method of claim 1, wherein the one or more image transformations comprises selecting a region of interest, wherein the image is either reduced to the region of interest or masked.

8: The method of claim 1, wherein the task is selected from one or more of the following tasks: classification, regression, segmentation, reconstruction, image quality enhancement.

9: The method of claim 1, wherein each image is or comprises a medical image, in particular a CT scan, an X-ray image, an MRI scan, a fluorescein angiography image, an OCT scan, a histopathological image, or an ultrasound image.

10: The method of claim 1, wherein the transformation agent and/or the task performing agent is or comprises an artificial neural network.

11: The method of claim 5, wherein the actor, the critic, and the task performing agent are trained in a combined training.

12: A computer system comprising:
a processor; and
a memory storing an application program configured to perform, when executed by the processor, an operation, the operation comprising:
receiving a training set comprising a multitude of images,
feeding each image of the training set to a transformation agent, wherein the transformation agent is configured to apply one or more image transformations to each image based, at least in part, on a set of transformation parameters,
feeding each transformed image to a task performing agent, wherein the task performing agent is configured to perform a task on each transformed image,
determining, for each task performed by the task performing agent, a task performance loss, and
training the transformation agent to optimize the set of transformation parameters, based, at least in part, on minimizing the task performance loss.

13: A non-transitory computer-readable storage medium comprising instructions that, when executed by a computer, cause the computer to:
receive a training set comprising a multitude of images;
feed each image of the training set to a transformation agent, wherein the transformation agent is configured to apply one or more image transformations to each image based, at least in part, on a set of transformation parameters,
feed each transformed image to a task performing agent, wherein the task performing agent is configured to perform a task on each transformed image,
determine, for each task performed by the task performing agent, a task performance loss, and
train the transformation agent to optimize the set of transformation parameters, based, at least in part, on minimizing the task performance loss.
